(19) United States
(12) Patent Application Publication
(10) Pub. No.: US 2008/0129513 A1
(43) Pub. Date: Jun. 5, 2008

(54) METHOD AND APPARATUS FOR RFID TAGS

(76) Inventors: Wolf Bielas, Chula Vista, CA (US); Sheshidher Nyalamadugu, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/944,298

(22) Filed: Nov. 21, 2007

Related U.S. Application Data
(60) Provisional application No. 60/860,873, filed on Nov. 22, 2006.
(60) Provisional application No. 60/860,874, filed on Nov. 22, 2006.
(60) Provisional application No. 60/860,876, filed on Nov. 22, 2006.

(51) Int. Cl. G08B 13/14

(52) U.S. Cl. 340/572.7

(57) ABSTRACT

A radio frequency identification (RFID) system include a reader and a tag. The RFID reader includes at least one reader antenna, the reader antenna is configured as a lossy loop antenna with a beam coverage area. The RFID tag includes a loop antenna, the tag loop antenna cooperates with the reader antenna to receive and transmit radio frequency signals between the reader antenna and the tag antenna when the tag is located with a near field distance from the reader antenna.

### RELATED APPLICATIONS

This application claims the benefit of U.S. Provisional Patent Application Ser. No. 60/860,873, filed Nov. 22, 2006, entitled “Flexible RFID Reader/Antenna System”, Ser. No. 60/860,874, filed Nov. 22, 2006, entitled “RFID Baggage Tag Method and Apparatus”, and Ser. No. 60/860,876, filed Nov. 22, 2006, entitled “RFID Tags For Personal Articles”, which are hereby incorporated herein by reference in their entirety.

### BACKGROUND

1. Field

This invention relates generally to a radio frequency identification (RFID) system, and more particularly, to an RFID reader/antenna comprising a plurality of antennas.

2. Background

A typical radio frequency identification (RFID) system includes at least one transmitting/receiving device, also referred to as a transceiver or reader, and at least one transponder device, also referred to as a tag. In a typical RFID system, the RFID reader includes a transmitter and antenna that transmits radio frequency (RF) energy. An RFID tag includes an antenna and electronics that receive the RF energy, modify the energy to encode information on to the RF signal, and reflect the modified RF energy back to the reader. The reader includes a receiver that receives the modified energy and decodes the received energy to recover the information from the tag.

As noted RFID readers include an antenna and transmit and receive electronics. There are many different configurations of RFID readers. For example, an RFID reader can be a handheld device that a person brings within close proximity to a tag to read it. In another example, the reader can be fixed, and read tags as they pass near the reader. Generally, the beam pattern of the antenna in the reader is optimized to focus the RF energy within a relatively small area. By focusing the RF energy into a small area the reader can generally obtain improved performance, such as receiving stronger signals from tags or being able to read tags at increased range.

RFID tags, or labels, are widely used to associate an object with an identification code. An RFID tag generally has a combination of an antenna and analog and/or digital electronics, which may include for example communications electronics, data memory, and control logic. In general tags can be active or passive. An active tag can include a power source, such as a battery to power the electronics of the tag. A passive tag does not include a power source but instead extracts power from the receiver RF energy to power the electronics of the tag. Active tags typically can operate at a longer range than passive tags, while passive tags are usually smaller and less expensive.

A passive RFID system typically operates in the following way. An RFID reader transmits a modulated RF signal to the RFID tag that includes an antenna and an integrated circuit RFID chip. The chip receives power from the antenna and responds by varying its input impedance and thus modulating the backscattered signal. One modulation type often used in RFID is amplitude shift keying (ASK) where the chip impedance switches between two states: one is matched to the antenna and another one is strongly mismatched. By modulating the backscattered signal the RFID chip can communicate information back to the reader.

RFID technology is used in a wide variety of applications to provide information related to items that RFID tags are connected to. For example, RFID tags can be used in conjunction with security-locks in cars, for access control to buildings, for tracking inventory and parcels, and other applications. As noted above, the beam pattern of the RFID reader is generally focused to cover a small area, requiring that RFID tag to pass through that small area for the reader to detect the tag.

Therefore, there is a need for improved coverage of RFID reader beam patterns and cooperation between RFID readers and tags.

### SUMMARY

System, methods and apparatus are described for a radio frequency identification (RFID) reader and tag. In one embodiment, a radio frequency identification (RFID) system includes an RFID reader that includes at least one reader antenna, the reader antenna configured as a lossy loop antenna with a beam coverage area. The RFID system also includes at least one RFID tag that includes a loop antenna, the tag loop antenna cooperates with the reader antenna to receive and transmit radio frequency signals between the reader antenna and the tag antenna when the tag is located with a near field distance from the reader antenna.

In one embodiment, the reader antenna in the RFID system transmits radio frequency energy in the ultra-high frequency band. In one embodiment, the reader antenna can be located on a shelf, in a display case, or other location.

In one embodiment, the RFID reader further includes a plurality of ports, each port in communication with a separate reader antenna. In another embodiments, the RFID reader includes a plurality of ports, each port in communication with an external multiplexer/switch that is in communication with a plurality of reader antennas. The RFID reader can also include a multiplexer/switch that selectively communications one of the plurality of ports to a transceiver.

In one embodiment a radio frequency identification (RFID) reader includes a transceiver that transmits and receives radio frequency signals. A plurality of reader antennas selectively in communication with the transceiver to emit and receive radio frequency energy, wherein each of the plurality of reader antennas comprise a lossy loop antenna. A decoder in communication with the transceiver to decode radio frequency signal received by the transceiver.

In one embodiment, the reader includes a multiplexer/switch that selectively communicates the plurality of reader antennas to the transceiver one at a time. In one embodiment, the reader includes a plurality of ports, each port in communication with an external multiplexer/switch that is in communication with a plurality of reader antennas, wherein the RFID reader further comprises a multiplexer/switch that selectively communications one of the plurality of ports to the transceiver. In one embodiment, the plurality of reader antennas cooperate with an RFID tag antenna to receive and transmit radio frequency signals between the reader antenna and the tag antenna when the tag is located with a near field distance from the reader antenna. In one embodiment, the plurality of reader antennas selectively transmit radio frequency energy in an ultra-high frequency band.

In one embodiment, the plurality of reader antennas are located on a shelf, or in a display case, or other location.

In another embodiment, a radio frequency identification (RFID) tag includes a loop antenna that is optimized for near field operation. An RFID chip in communication with the loop antenna, wherein the loop antenna receives and transmits radio frequency energy from an RFID reader antenna when the tag is located with a near field distance of the reader antenna.

In one embodiment, the loop antenna of the tag operates in an ultra-high frequency band. In one embodiment, the tag is attached to a piece of jewelry. In another embodiment, the tag is attached to a personal item.

In one embodiment the reader and tag antennas can be formed using one or more of the following techniques. The reader and tag antennas do not need to be formed using the same technique. In one embodiment an antenna is with conductive ink. The conductive ink can be selectively deposited to form the antenna. In another embodiment, an antenna can be formed using a conductive material that is formed by electroplating, by physical deposition. by chemical deposition, or the like.

Other features and advantages of the present invention should be apparent after reviewing the following detailed description and accompanying drawings which illustrate, by way of example, aspects of the invention.

### BRIEF DESCRIPTION OF THE DRAWINGS

These and other aspects, advantages and details of the present invention, both as to its structure and operation, may be gleaned in part by a study of the accompanying exemplary drawings, in which like reference numerals refer to like parts. The drawings are not necessarily to scale, emphasis instead being placed upon illustrating the principles of the invention.

FIG. 1 is a block diagram of an RFID system.

FIG. 2 is a block diagram of an embodiment RFID system in accordance with aspects of the invention.

FIG. 3 is a block diagram of an embodiment of an RFID reader.

FIG. 4 is a block diagram of another embodiment of an RFID reader.

FIG. 5 is a block diagram of example antenna designs that can be used in the tags of FIGS. 2-4.

FIG. 6 is a block diagram of an embodiment of a reader antenna that can be used with the readers illustrated in FIGS. 2-4.

FIG. 7 is a block diagram of another embodiment of a reader antenna 208 that can be used with readers 202 illustrated in FIGS. 2-4.

### DETAILED DESCRIPTION

Certain embodiments as disclosed herein provide for methods, systems, and apparatus for RFID reader/antenna arrangements. After reading this description it will become apparent how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

As noted, RFID tagging is an emerging technology used for identifying, authenticating and tracking objects. RFID has become widely used in virtually every industry, including transportation, manufacturing, asset tracking, airline baggage tracking, and highway toll management. As opposed to more traditional technologies involving printed barcodes and line-of-sight scanning devices, the RF identification process involves the transmission and reception of radio waves between the tag, which contains the transponder, and the reader, or base station. The transponder typically comprises a semi-conductor chip comprised of RF circuits, logic and memory, and an antenna, which allows reception and transmission of radio waves by radiating or absorbing energy in a variety of bandwidths.

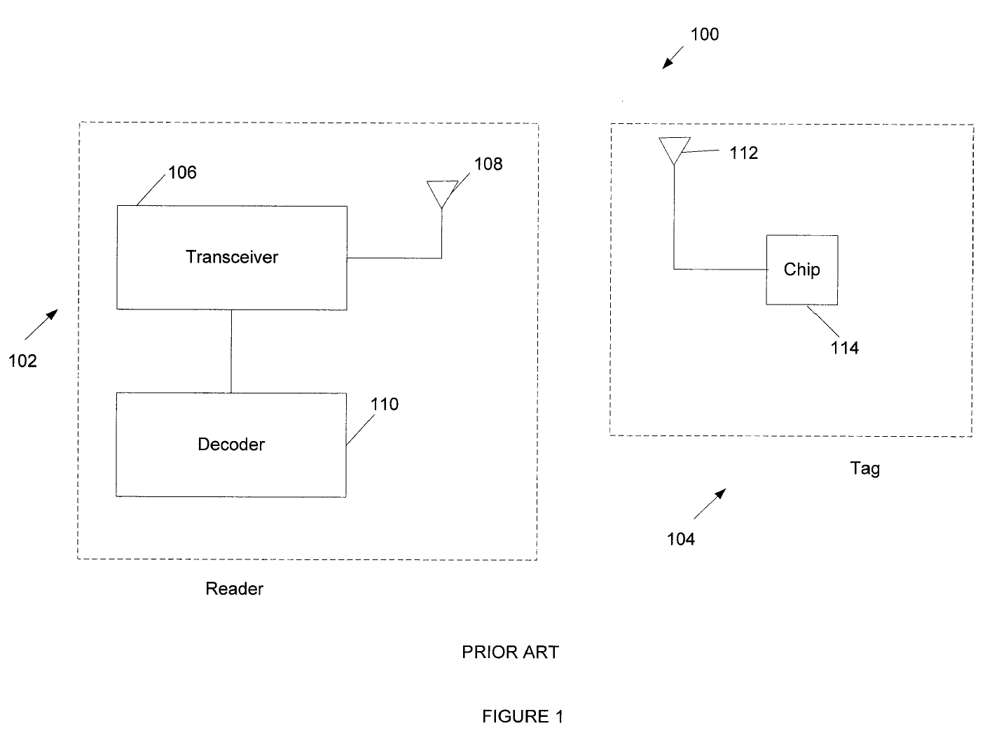

FIG. 1 is a block diagram of an RFID system 100. As shown in FIG. 1, the RFID system 100 includes at least one reader 102 and at least one tag 104. The reader 102 can include a transceiver 106 that transmits and receives RF energy, or signals, via an antenna 108. The reader 102 also includes a decoder 110 that decodes RF energy, or signals, received from a tag 104.

The tag 104 can include an antenna 112 and an RFID chip, or integrated circuit (IC) 114. In the example illustrated in FIG. 1, the tag 104 is a passive tag and does not include a power source. In operation, the tag 104 receives RF energy transmitted by the reader 102 at the antenna 112. Power can be extracted from the received RF energy and used to power the RFID chip 114. The RFID chip 114 modifies the received RF energy in accordance with information programmed into the chip. The modified energy is reflected, or backscattered, to the reader 102 where it is received by the transceiver 106 via the antenna 108. The received modified signal is then communicated to the decoder 110 that decodes the information from the received modified signal.

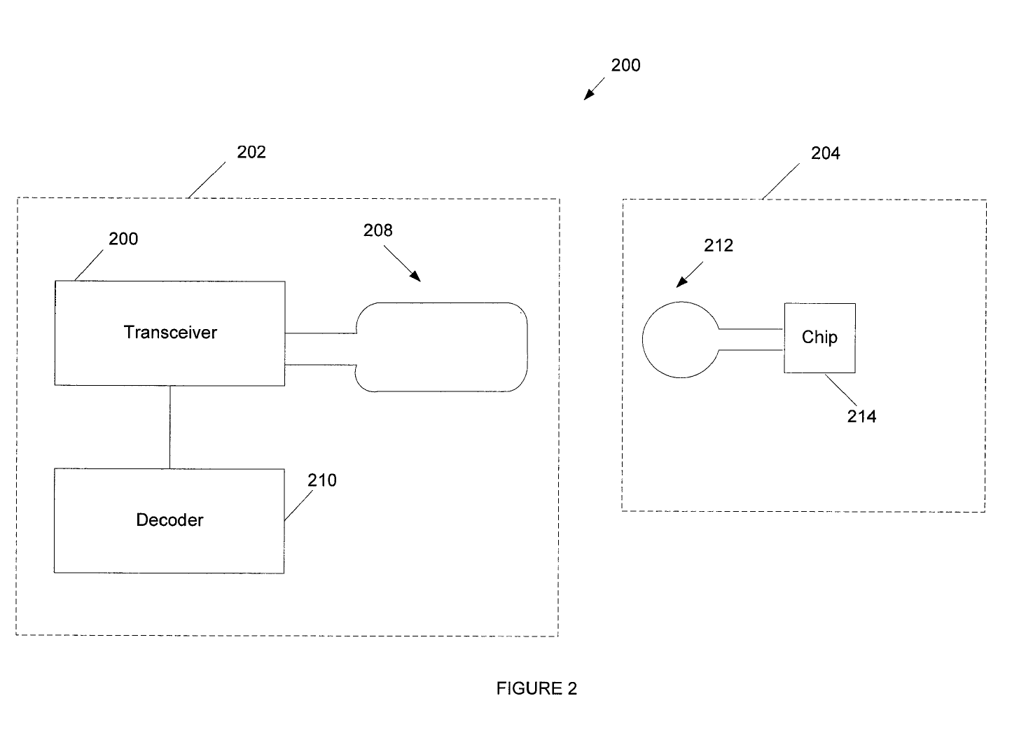

FIG. 2 is a block diagram of an embodiment RFID system 200 in accordance with aspects of the invention. As shown in FIG. 2, the example RFID system 200 includes at least one reader 202 and at least one tag 204. The reader 202 includes a transceiver 206, antenna 208 and a decoder 210. The reader antenna 208 is a “lossy loop” antenna. The configuration of the antenna 208 is selected such that a beam pattern of the antenna covers a large area, or large foot print, around the antenna. Because the beam pattern covers a large area, the RF energy transmitted from the antenna is spread out over a large region, the intensity of the RF energy drops off rapidly as the distance from the antenna increases. In one embodiment, the RF energy transmitted by the reader 202 is in the ultra-high frequency (UHF) band or the radio spectrum. In other embodiments, the RF energy transmitted by the reader 202 can be in other frequency bands, for example, the high frequency (HF) band, the ultra-high frequency (UHF) band, or other desired frequency band. The antenna 208 can be configured to obtain the desired coverage area, and other antenna characteristics, in accordance with the frequency band used by the reader 202.

The reader antenna 208 can be rigid or flexible. In one embodiment, the reader antenna 208 can be conductive material, such as conductive ink, attached to a flexible material so the antenna can be formed into a desired shape. For example, the reader antenna 208 can be a conductive ink that is attached to a piece of polyester, or paper, or other flexible non-conductive substrate material. In addition, the substrate material can have a pressure sensitive adhesive on one side so that the antenna can be attached in a desired location. In other embodiments, the substrate does not have a pressure sensitive material.

In one embodiment, the flexible reader antenna 208 can be manufactured by selectively depositing a conductive material, such as a conductive ink, on to a flexible substrate as the substrate material is pulled off of a roll. In this way, the flexible reader antenna 208 can be made to any desired shape and size. In addition, the substrate material can be cut, or formed, into any desired shape. For example, the substrate material does not need to be square or rectangular, but can be any regular or irregular shape. In addition, the conductive material forming the antenna does not need to be a regular shape, but can be any regular or irregular shape.

In one embodiment, the reader antenna 208 can be made with a conductive material deposited onto a flexible substrate with pressure sensitive adhesive on one side of the substrate. And the substrate attached to a surface. In other words, the conductive material on the flexible substrate can be similar to a piece of tape that can be formed into any desired shape for the antenna.

Also shown in FIG. 2 is an embodiment of an RFID tag 204. The tag 204 includes an antenna 212 and an RFID chip 214. The antenna 212 is typically a small, and substantially a loop in shape. The general shape of the antenna 212 is configured to obtain desired characteristics in accordance with the frequency band used by the reader 202. usually used in RFID systems that operate in the high frequency (HF) band of the radio spectrum. In general, the antenna 212 in the tag 204 is configured as a loop antenna that is optimized for near-field applications.

The tag antenna 212 can be formed on a rigid or flexible substrate. For example, similar to the discussion of the reader antenna, the tag antenna 212 can be conductive material, such as conductive ink, attached to a flexible material so the antenna can be formed into a desired shape.

In the embodiment of FIG. 2, the reader transmits a UHF RF signal. The antenna 212 of the tag 204 receives the RF energy. Because, the antenna 212 is optimized for near-field applications the operating range, or range from the reader 202 to the tag 204, is limited to short distances. Because of the small form factor of the antenna it is possible to attach the tag 204 to small items, such as personal items like jewelry, eyewear, watches, or other personal articles.

In one embodiment, the RFID system of FIG. 2 can be used to detect the presence or absence of personal items in a storage cabinet or display case. For example, the reader 202 can be installed in, or above or below a shelf in a store, office or home, or the like. For example, the reader can be installed on a shelf in a jewelry display case, such as a display case in a jewelry store. Items, such as rings, pendants, earrings, or other items can have a tag 204 attached to it. Because of the small size of the antenna 212 in the tag 204, the tag is small and does not interfere with displaying the item. With the short operating range of the RFID system, the tagged items will be sensed when they are placed in the display case, but they will be out of range, and not sensed, when they are removed from the display case to be shown or sold.

In some cases it may be desirable for an RFID reader to cover a very large area while being able to maintain a desired resolution. For example, it may be desirable to cover a large area with a reader but to also be able to know where within that area covered by the reader a tag is located. In the example of the display case, the case may be large and the reader may need to cover the entire case. In addition, it may be desirable to know wherein the display case a particle items is located. For example, a store owner may want to keep track of how often a particular item is removed from the display, indicating how many time the item is requested to be shown to a customer. In addition, the store owner may keep track of how often items from particular locations with the display case are removed to show to a customer. In this way, the store owner can determine which locations in the display attract the most attention from customers and they arrange items in the display accordingly.

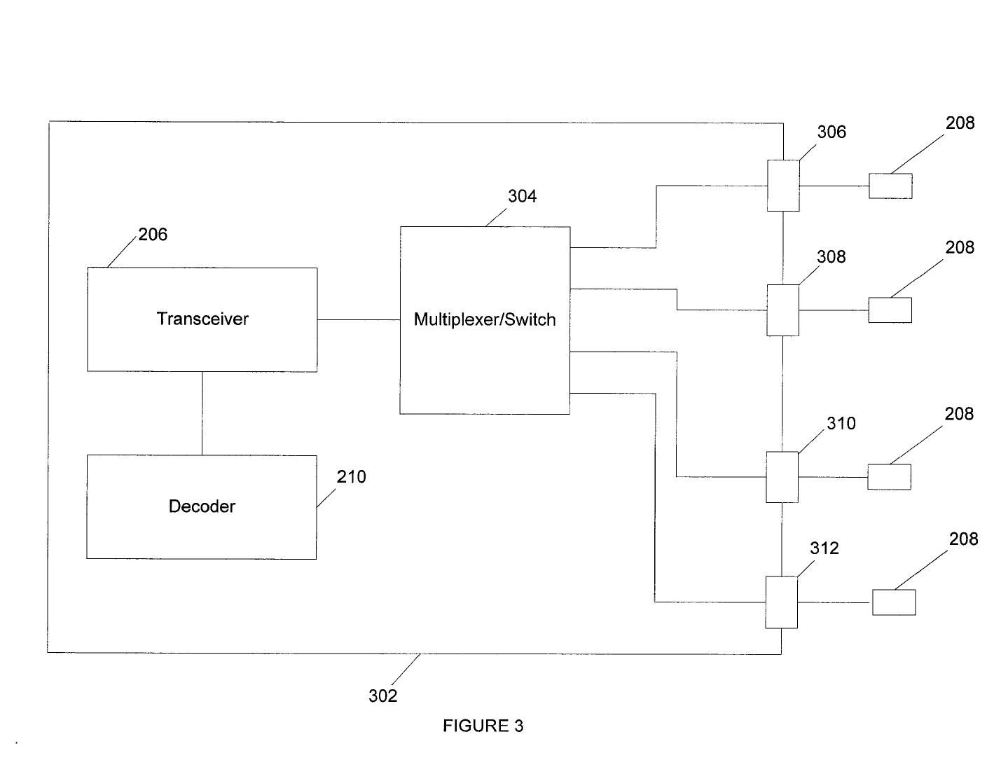

FIG. 3 is a block diagram of an embodiment of an RFID reader. As shown in FIG. 3, the reader includes a base station 302. In the base station 302 is a transceiver 206 and a decoder 210. The base station 310 also includes a multiplexer/switch 304. In the example of FIG. 3, the multiplexer/switch 304 selectively communicates one of four input ports 306, 308, 310, or 312 to the transceiver 206. In this way, four different lossy antennas, one coupled to each of the four input ports 306, 308, 310, and 312, can be selectively coupled to the transceiver 206. The reader of FIG. 3 can thus use four antennas to cover a larger area while still maintaining a desired resolution.

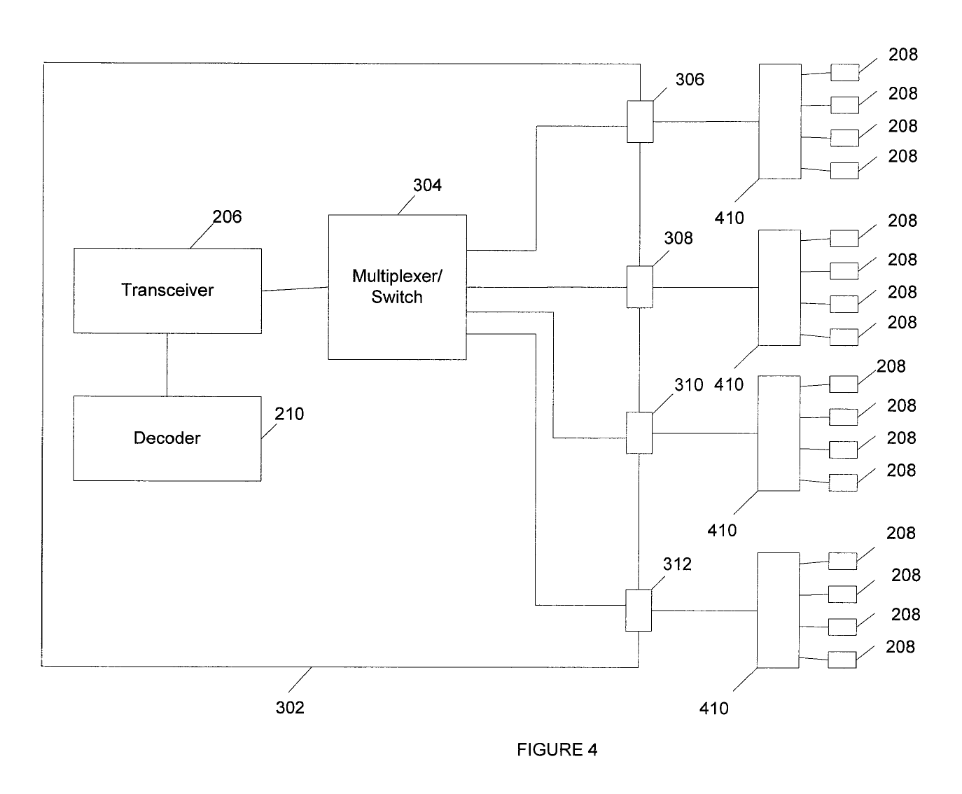

FIG. 4 is a block diagram of another embodiment of an RFID reader. The reader illustrated in FIG. 4 is similar to the base station 302, transceiver 206, decoder 210 and multiplex/switch 304 of FIG. 3. In the embodiment of FIG. 4, an external multiplexer/switch 410 is in communication with each of the ports 306, 308, 310, and 312 of the base station 302. Also connected to the external multiplexer/switch 410 is four lossy antennas 208. Thus, in the example of FIG. 4, four antennas 208 can be selectively coupled by an external multiplexer/switch 410 to each of the four ports 306, 308, 310, and 312 of the base station, that are selectively coupled by the multiplexer/switch 304 to the transceiver 206. Thus, in the embodiment of FIG. 4, there are sixteen antenna that can be selectively coupled to the base station 302.

While the examples illustrated in FIGS. 3 and 4 show a multiplexer/switch 304 in the base station that selectively couples one of four ports 306, 308, 310, and 312 to the transceiver, in other embodiments there can be other numbers of ports selectively coupled to the transceiver. Likewise, there can be multiple transceivers in the base station with one transceiver per port, or in any combination of the above embodiments. Also, while FIG. 4 shows four antenna 208 selectively coupled by the external multiplexer/switch 410, in other embodiments, there can be other numbers of antenna 208 selectively coupled by the external multiplex/switch 410. In addition the number of external antenna selectively coupled by one external multiplex/switch 410 can be different that the number of antenna selectively coupled by another multiplexer/switch 410.

In one embodiment, such as illustrated in FIGS. 3-4. a flexible RFID reader antennae 208 includes a plurality of reader antennas 208, or antenna units that can be selectively coupled, or linked together, to act as a single, flexible chain. Each of the reader antennas 208 are selectively operatively connected to the transceiver 206 in the RFID reader 202.

In one embodiment, a group of reader antennas 208 that are linked together in one flexible chain can be placed underneath any surface on which items with tags 204 are placed. For example, in a jewelry case, the chain of reader antennas 208 could be taped underneath the surface of the case surface (typically a wooden shelf, such as plywood) in such a way that any RFID tagged items sitting on that surface would be read. The reader antennas 208 would not be visible and could be installed inside cabinets, pantries, in shelving, or underneath any surface on which items are placed.

Using multiple reader antennas 208 that are linked together permits the RFID reader to cover a large area while also permitting ease of placement and installation of the antennas 208. As noted, one “chain” of reader antennas 208, in effect, becomes one flexible reader antenna 208. The flexibility improves installation of the antennas 208 in desired locations, for example, the ability to place the reader underneath a surface in such a way as to maximize coverage. As noted above, because the reader antenna 208 can be formed on a flexible substrate material, the antenna can be formed to any desired form.

The flexible reader antenna 208 configuration described above allows for the creation of antenna to be designed for applications that previously required the use of standard fixed antenna. In one embodiment, the reader antenna 208 can be made uses etching, or conductive ink, to turn many standard surfaces, such as retail surfaces, into RFID reader antennae 208 surfaces. In one embodiment, the reader antenna 208 can be formed by a conductive ink on a flexible substrate, the flexible substrate having a pressure sensitive adhesive on one side, such that the conductive ink is “taped” on a surface in any desired shape.

The RFID system of FIGS. 2-4 can be configured for near field reads, far field reads, or both. Antennas in the system can be tuned for an application that uses the system. In one embodiment, the reader antenna 208 is frequency agnostic and is designed to work with all generally available readers 202. In addition, a connection between the antenna 208 and the reader 202 can be adapted to various manufacturers' connection points.

In one embodiment, the RFID tags 204 are incorporated into labels. For example, the tags 204 can be incorporated into price tags, or other tags conventionally used in the jewelry and personal articles area. Such tags are commonly known as “ring (or dumbbell) labels” and “rattail labels.” In one embodiment, the tag 204 comprises a label in the shape of a ring label or a rattail label, and includes at least one RFID antenna 212 operatively connected to an RFID chip 214. As noted, using techniques similar to those described for the reader antenna, the tag antenna can be on a flexible substrate.

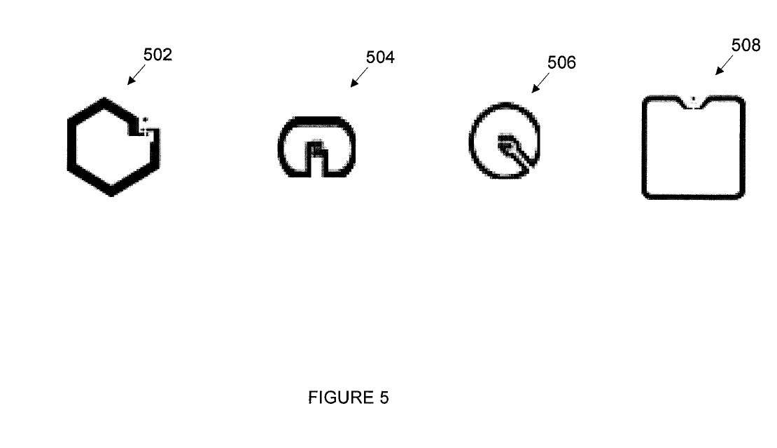

FIG. 5 is a block diagram of example antenna designs that can be used in the tag 204 of FIGS. 2-4. In FIG. 5, four examples of tag antennas 502, 504, 506, and 508 are illustrated.

As shown in FIG. 5, the antennas are substantially loops in shape. Loop antennas can be a variety of different forms, such as rectangle, square, triangle, ellipse, circle, and other configurations. The antennas illustrated in FIG. 5 are generally designed to operate in the UHF frequency band and have been optimized for the near-field.

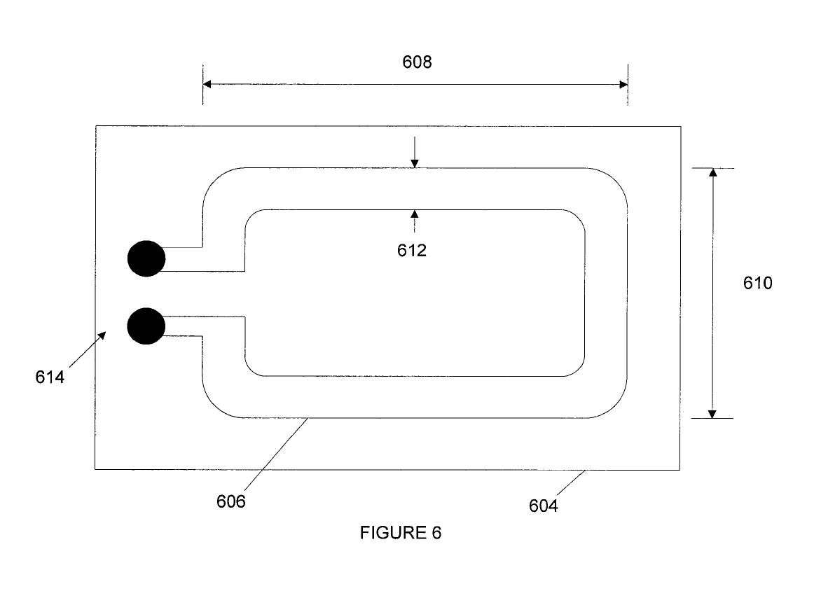

FIG. 6 is a block diagram of an embodiment of a reader antenna 208 that can be used with the readers 202 illustrated in FIGS. 2-4. As shown in the example of FIG. 6, the reader antenna is formed by a conductive material, such as a conductive ink, 604 on a flexible substrate 606. The flexible substrate can be placed on a surface in any desired form. During manufacture of the antenna, the conductive material 606 can be deposited on the flexible substrate 606 to form an antenna with any desired length 608, width 610 and thickness 612.

The antenna in FIG. 6 is configured for approximately 50 ohms impedance. In other configurations other impedances can be selected. The antenna 208 includes attachment points 614. For example, the attachments points can be solder tabs or vias, such as in a circuit board. In other embodiments, the attachments points may be a connector.

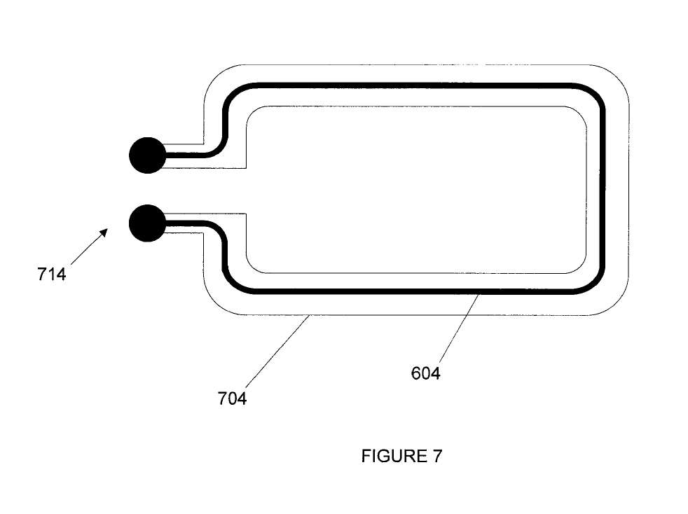

FIG. 7 is a block diagram of another embodiment of a reader antenna 208 that can be used with readers 202 illustrated in FIGS. 2-4. In the embodiment of FIG. 7. the antenna is formed by a flexible substrate with a conductive material such as a conductive ink 606 deposited on the substrate. In one embodiment, the substrate can have a pressure sensitive adhesive on one side of the substrate. In the example of FIG. 7, the substrate can be attached to a surface in any desired pattern to form the antenna. In other words, the substrate can be “taped” to a surface to form the antenna. Again, the antenna can have any desired length, width and thickness. In addition, the antenna can be an irregular shape. The antenna can have attachment points 714 installed.

The reader antenna can be a variety of different forms, such as rectangle, square, triangle, ellipse, circle, and other configurations. The antenna illustrated in FIG. 6 is generally designed to operate in the UHF frequency band and has been optimized for the near-field.

In one embodiment, an RFID tag 204 can have a surface attached directly to an object, adhesively or otherwise. In another embodiment, an RFID tag 204 can be secured to objects by other means, for example by use of a plastic fastener, string, embedding of implantation, or other securing means. In one embodiment, an RFID tag 204 device generally utilizes an antenna structure that is operatively coupled to electrical or electronic components, in the form of a chip or a strap (such as is described in U.S. Pat. No. 6,606,247 incorporated herein by reference in its entirety), to communicate with a receiver or transceiver device such as a detector or reader. The antenna structure can utilize conductive material arranged on a dielectric substrate in a suitable array. The antenna structure can be coupled to the chip or strap to allow communication between the RFID device and the reader and the detector. A wide variety of antenna sizes, shapes, and configurations may be utilized to achieve various communication characteristics, depending on many factors.

The conductive material of the antenna structure may be attached on a dielectric substrate by any of a variety of suitable methods. One such method involves printing of a conductive ink to form the antenna structure. Such conductive inks may include any of a variety of suitable electrically conductive materials, including conductive metal particles, carbon particles, or conductive polymer particles.

In one embodiment, an RFID antenna, either a reader antenna 208 or a tag antenna 212, can be constructed according to various techniques. For example, an RFID antenna can include a non-conductive substrate made of any of a variety of suitable materials, such as a suitable polymeric material. Examples of suitable substrate materials include, but are not limited to, high Tg polycarbonate, poly(ethylene terephthalate), polyarylate, polysulfone, a norbornene copolymer, poly phenylsulfone, polyetherimide, polyethylenenaphthalate (PEN), polyethersulfone (PES), polycarbonate (PC), a phenolic resin, polyester, polyimide, polyetherester, polyetheramide, cellulose acetate, aliphatic polyurethanes, polyacrylonitrile, polytrifluoroethylenes, polyvinylidene fluorides, HDPEs, poly(methyl methacrylates), a cyclic or acyclic polyolefin, or paper, among others.

Conductive material used in the fabrication of an RFID antenna, either a reader antenna 208 or a tag antenna 212, can include any suitable conductive materials, such as suitable conductive inks. Such conductive inks may include inks with suitable conductive materials such as conductive metal or non-metal particles. Examples of suitable conductive materials include copper particles, nickel particles, silver particles, aluminum particles, various metal alloy particles, carbon particles, and conductive polymer particles. Examples of conductive polymers include intrinsically conductive polymers such as polyethylenedioxythiophene (PEDOT), polypyrrole (PPy), or polyaniline (PANI), among others.

Conductive inks may be selectively deposited to form the antenna structure by any of a variety of suitable processes, such as flexo printing, offset printing, and gravure printing, screen printing, or any other digital printing. The resistance may be less than 100 ohms per square. (Resistivity can be measured on a strip with a 10:1 length to width ratio. Ohm/square is determined by dividing the resistance measurement along the length by 10.) Of course, it will be appreciated that the choice of material may depend on such factors as cost and availability of conductive materials, and the level of conductivity required.

The RFID antenna structures may also include conductive materials deposited in other ways, such as by electroplating, physical deposition, or chemical deposition. For example, a layer of copper may be deposited by such methods. A selective removal process such as etching may be used to remove suitable portions of the deposited conductive material.

In one embodiment, an RFID tag, or transponder, generally comprises an RFID antenna and any of a variety of combinations of wireless communication devices (RFID chips) with conductive leads coupled thereto to facilitate electrical connection. The RFID chip may be coupled to the antenna structure by any of a variety of suitable methods, such as, for example, by use of a conductive adhesive, by use of welding and/or soldering, or by electroplating.

It will be appreciated that an RFID device, such as an RFID tag or RFID reader antenna, may have other layers and/or structures. For example, an RFID device may have an adhesive layer for use in adhering the RFID device to an object. The adhesive layer may have a peel layer thereupon for protecting the adhesive prior to use. The RFID device may also have other layers, such as protective layers, and/or a printable layer for printing information thereupon. It will be appreciated that the RFID device may also include additional suitable layers and/or structures, other than those mentioned herein.

Various illustrative implementations of the present invention have been described. However, one of ordinary skill in the art will see that additional implementations are also possible and within the scope of the present invention.

Accordingly, the present invention is not limited to only those implementations described above. Those of skill in the art will appreciate that the various illustrative modules and method steps described in connection with the above described figures and the implementations disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Thus, it is to be understood that the description and drawings presented herein represent example implementations of the invention and are therefore representative of the subject matter which is broadly contemplated by the present invention. It is further understood that the scope of the present invention fully encompasses other implementations and that the scope of the present invention is accordingly limited by nothing other than the appended claims.

1. A radio frequency identification (RFID) tag comprising:
a loop antenna that is optimized for near field operation;
an RFID chip in communication with the loop antenna, wherein the loop antenna receives and transmits radio frequency energy from an RFID reader antenna when the tag is located with a near field distance of the reader antenna.

2. The tag of claim 1, wherein the loop antenna operates in an ultra-high frequency band.

3. The tag of claim 1, wherein the tag is attached to a piece of jewelry.

4. The tag of claim 1, wherein the tag is attached to a personal item.

5. The tag of claim 1, wherein the loop antenna comprises conductive ink.

6. The tag of claim 5, wherein the conductive ink is selectively deposited to form the antenna.

7. The tag of claim 1 wherein the loop antenna comprises conductive material that is formed by electroplating.

8. The tag of claim 1, wherein the loop antenna comprises conductive material that is formed by physical deposition.

9. The tag of claim 1, wherein the loop antenna comprises conductive material that is formed by chemical deposition.
